(19) United States
(12) Patent Application Publication
(10) Pub. No.: US 2002/0087779 A1
(43) Pub. Date: Jul. 4, 2002

(54) High-speed way select scheme for a low power cache

(76) Inventor: Kevin Zhang, Portland, OR (US)

Correspondence Address: Kenyon & Kenyon, Suite 600, 333 W. San Carlos Street, San Jose, CA, 95110, US

(21) Appl. No.: 09/752,873

(22) Filed: Dec. 29, 2000

(51) Int. Cl. G06F 12/00

(52) U.S. Cl. 711/3; 711/128

(57) ABSTRACT

A cache access system is provided. The cache access system includes a plurality of ways coupled to decoders. Each decoder is to find a data location in one way based on an address. The cache access system also includes a tag unit to compare the address with a tag array and to generate a hit/miss signal. Sense amplifiers are coupled to each of the ways, wherein one of said sense amplifiers is to read data from the data location if it receives said hit/miss signal as a hit.

### BACKGROUND OF THE INVENTION

1. Field of the Invention

The present invention relates generally to providing a way select scheme for a low power cache. More particularly, the present invention relates to providing a way select scheme for high-speed cache access while maintaining low power consumption.

2. Description of the Related Art

With the advent of miniaturization technology, engineers have been able to design and manufacture smaller and smaller components to build microprocessors, resulting in a phenomenal increase in the speed and performance of computer systems. As processors are currently able to attain speeds greater than 1 gigahertz (Ghz), the major limiting factor in the overall performance of a computer system is the speed at which the processor can access memory. Because the speed of random access memory (RAM) will always lag far below that of a central processing unit (CPU), on-chip cache design is becoming more and more important to the performance of today's microprocessor.

FIG. 1 illustrates a conventional microprocessor 10 having a cache 12. Microprocessor 10 also includes a CPU 14, an input/output (I/O) module 16, and a control module 18. Each component of microprocessor 10 is coupled to a data bus, which facilitates communication between each of the components. CPU 14 primarily functions as a number crunching unit and may include multiple arithmetic logic units (ALU), such as integer execution units and floating point units. Control module 18 commands CPU 14 to execute programs and I/O module 16 facilitates input and output of microprocessor 10.

Cache 12 is a form of memory (such as synchronized dynamic random access memory (SDRAM)), which is on-chip and configured to function at much higher speeds than standard RAM. Cache 12 is typically divided into separate classifications or levels. For example, if a cache is designated as level one (L1), it is the smallest and quickest cache located closest to the CPU. Modem microprocessors also typically include L2 and L3 caches, which are larger and slower than an L1 cache. The caches store information that must be accessed frequently by the CPU. By accessing and utilizing the cache as much as possible instead of much slower standard memory, the overall performance of a computer is enhanced substantially.

When a CPU requires data, it goes into memory (i.e., a cache) to fetch the data using an address to locate the correct data. The address is broken into two parts, an index and a tag. All the data stored in a cache has also has a tag, which is stored in a tag array. While the index represents the correct location of the data, it is possible for multiple sets of data to have the same index in a cache, but reside in different ways or blocks. This type of a cache is known as an associative cache. Caches that have only one physical location for each address are known as direct map caches.

When a cache is accessed by a data request, a comparison is done between the tag of the address and the tag of the way to see if there is a match. A hit/miss signal is generated depending on the result of the comparison. If there is a match, the signal is a hit, which indicates that the right data and the right way have been found. If the tags do not match, then the signal is a miss.

The main advantage of the associative cache over a direct map cache is that it has a higher hit rate and a lower miss rate. This is because data in an associative cache is not replaced as often as data in a direct map cache because multiple sets of data can occupy the same location, known as a way. The more ways an associative cache has, the greater the hit rate. Therefore, associativity provides much more flexibility than direct mapping in terms of stored data and accessed data.

FIG. 2 illustrates a conventional associative cache 20 and a data request address 22. Address 22 includes an index 24 and a tag 26. Associative cache 20 includes a multiplexor (MUX) 28 coupled to each of four ways 0, 1, 2, and 3, which store data. MUX 28 is receives data from each of four ways 0, 1, 2, and 3 and prepares the data for transmitting to the CPU. Associative cache 20 also includes tag units 38, 40, 42, and 44, one for each way in the cache. Tag units 38, 40, 42, and 44 are coupled to comparators 46, 48, 50, and 52, which compare address tags with data tags and generate hit/miss signals for each way 0, 1, 2, and 3. Each of the hit/miss signals are then input into MUX 28 to choose which set of data is output.

Associative cache 20 can respond to a data request with either a series access scheme or a parallel access scheme. In a series access scheme, tag units 38, 40, 42, and 44 perform a simultaneous tag comparison and comparators 46, 48, 50, and 52 before any data is accessed. After four hit/miss signals are generated, it is then possible to determine which way the correct data belongs to. For example, if comparator 46 generates a hit signal and comparators 48, 50, and 52 generate a miss signal, then way 30 will be accessed for the correct data.

In a parallel access scheme, data is retrieved from all of ways 0, 1, 2, and 3 at the same time the tag comparison is done. After the data is retrieved, the result of the tag comparison makes it possible to select the correct data requested. In this case, selecting the correct data takes place after data retrieval, and the unneeded data (from three of the four ways) is simply discarded. While parallel access is much quicker than series access (data retrieval occurs during and not after hit/miss signals are generated), the speed also comes at a huge power cost (because four times the needed data was retrieved).

While series access to the cache is slow, parallel access schemes are typically limited by modem processors to use in only the very smallest and highest speed caches where power must be sacrificed in favor of speed. Otherwise, the power penalty is simply too great, particularly since the current trend is towards larger caches and higher associativity (i.e. more ways, resulting in an even steeper power penalty). Therefore, it is highly desirable to have a way select scheme that provides for high-speed cache access and maintains low power consumption.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 illustrates a conventional microprocessor having a cache.

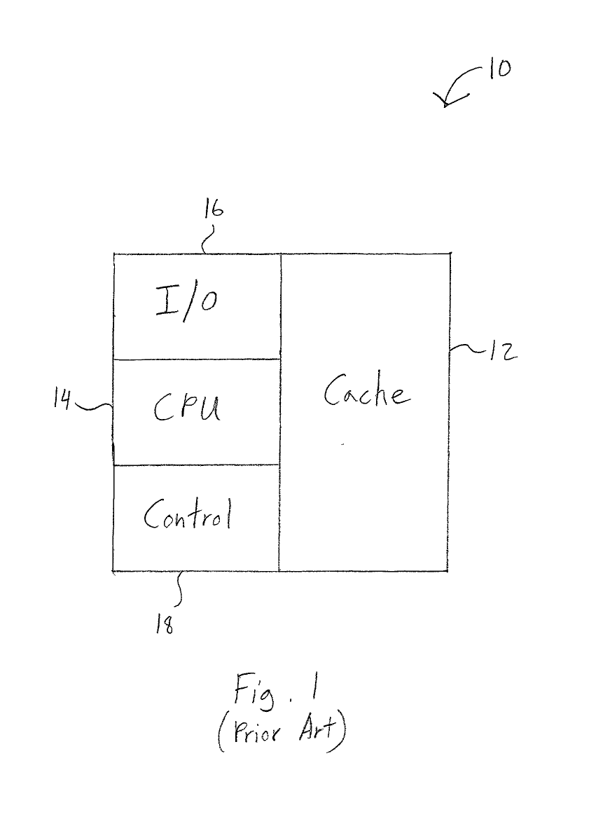

FIG. 2 illustrates a conventional associative cache and a data request address.

FIG. 3 illustrates an associative cache in accordance with one embodiment of the present invention.

FIG. 4 illustrates another associative cache in accordance with one embodiment of the present invention.

FIG. 5 is a flow chart of a method for way select.

### DETAILED DESCRIPTION

A method and apparatus for routing and delivering interrupt requests in a multi-node system is provided. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

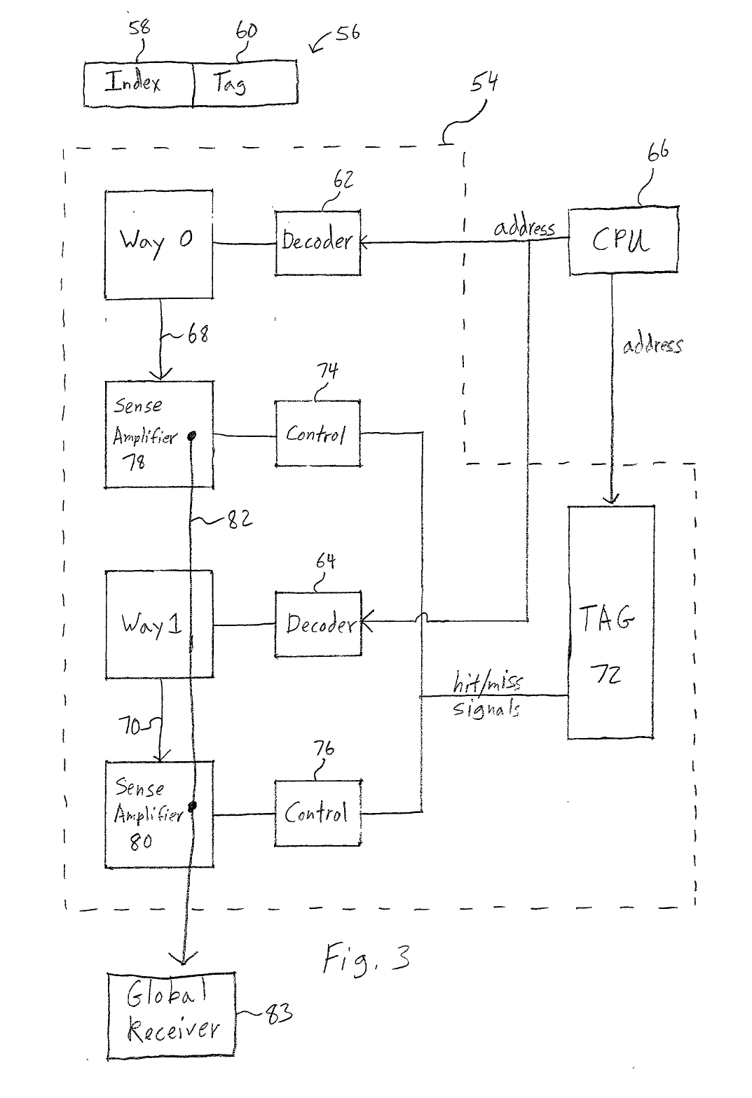

FIG. 3 illustrates a two way associative cache 54 and an address 56 in accordance with one embodiment of the present invention. Address 56 includes an index 58 and a tag 60. Associative cache 54 includes decoders 62 and 64 for receiving index 58 from a CPU 66. Decoders 62 and 64 are coupled to ways 0 and 1, each of which store data. Associative cache 54 also includes a tag comparison unit 72 for receiving tag 60. Tag comparison unit 72 is coupled to controls 74 and 76, each of which is in turn coupled to sense amplifiers 78 and 80.

When CPU 66 requires data from associative cache 56, CPU 66 transmits address 56 to decoders 62 and 64 and tag comparison unit 72. Decoders 62 and 64 use index 58 to identify the wordlines in which the data is located, in this case, ways 0 and 1. At the same time, tag comparison unit 72 begins looking up the tags of ways 0 and 1. In a second decoding step, a wordline decoding is performed at the block level for each way finding a location of the data requested. Differential signals are generated on a pair of local bitlines 68 and 70, coupling ways 0 and 1 to sense amplifiers 78 and 80. However, the data is not read or sensed until a hit signal has been confirmed because data sensing consumes a great deal of power.

At the same time as wordline decoding is occurring, tag comparison unit 72 compares tag 60 with tags from ways 0 and 1 generating a hit signal if the tags match and a miss signal if the tags do not match. Finally, controls 74 and 76 receive the hit/miss signals for each way from tag comparison unit 72. If a hit signal is received for way 0 by control 74, then sense amplifier 78 is fired and data is sensed down a global bitline 82 to a global receiver 83. If a hit signal is received for way 70 by control 76, then sense amplifier 80 is fired and data is sensed down global bitline 82 to global receiver 83.

In this manner, embodiments of the present invention result in associative caches that access data quickly and operate at low power. Thus, associative cache is able to combine the advantages of both serial and parallel cache accesses and avoid the disadvantages. On one hand, the cache latency of the present invention is lower than that of a series access because both decoding and tag comparison occur at the same time. On the other hand, associative cache maintains low power by reading data after the hit/miss signals have determined the particular way from which the data should be read. In addition, because associative cache 54 fires only one sense amplifier, it only requires one global bitline 82 instead of the four bitlines required in caches of the prior art. Therefore, the present invention reduces the amount of metal and wiring in the cache, which translates into substantial monetary savings.

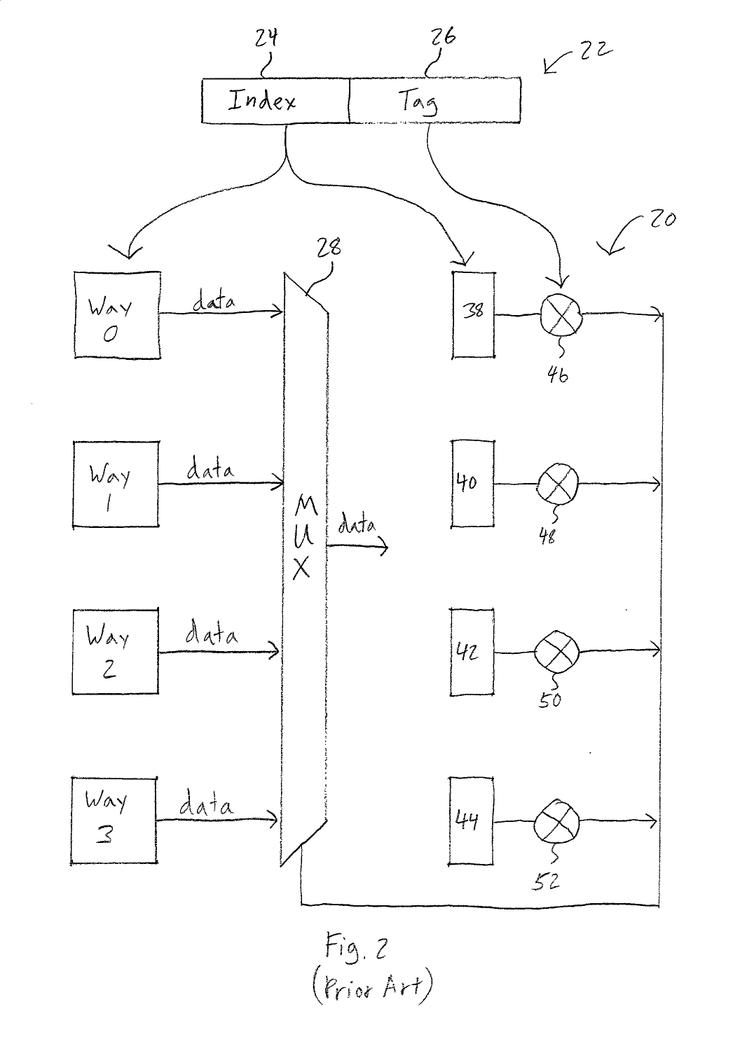

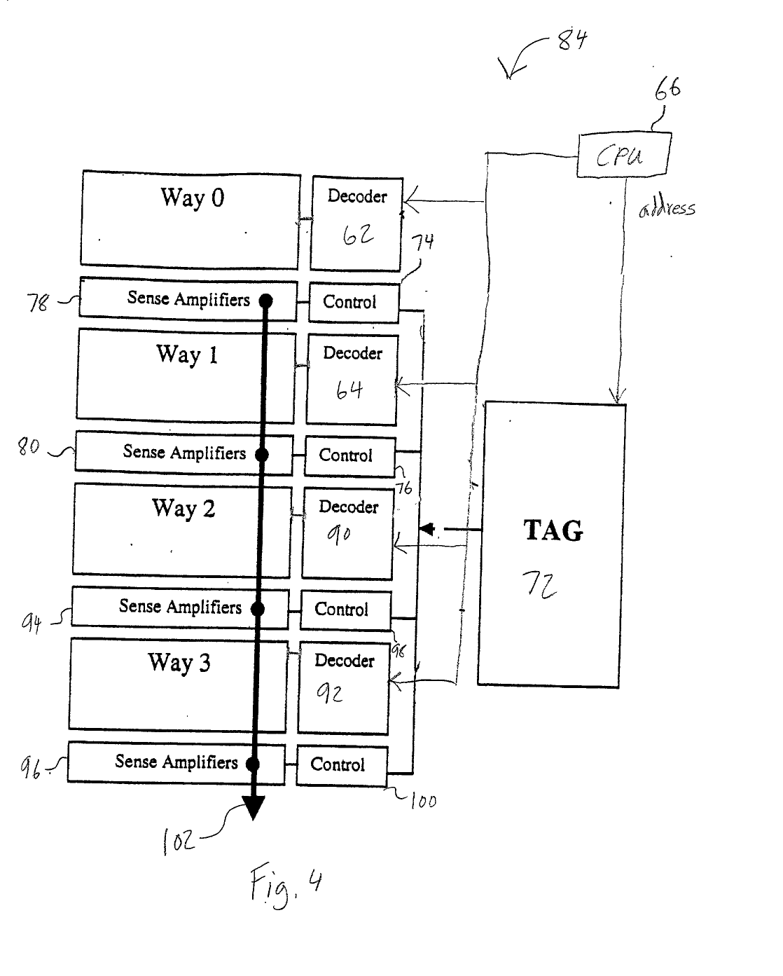

FIG. 4 illustrates another associative cache 84 in accordance with one embodiment of the present invention. Associative cache 84 is similar to associative cache 54 shown in FIG. 2 and serves to show that the present invention can easily be applied to embodiments having four ways, eight ways, etc. Associative cache 84 further includes ways 2 and 3, which are coupled to decoders 90 and 92. As with decoders 62 and 64, decoders 90 and 92 also receive addresses from CPU 66 to find a location in the corresponding way.

Associative cache 84 also includes sense amplifiers 94 and 96 coupled to control units 98 and 100. Control units 74, 76, 98, and 100 all receive hit/miss signals from tag comparison unit 72. A total of three miss signals and one hit signal will be received in a cache hit access. The control unit that receives the hit signal will then proceed to fire one of the sense amplifiers. All of the sense amplifiers 78, 80, 94, and 96 are coupled to a global bitline 102, which reads data after it has been sensed.

As with two way associative cache 54, four way associative cache 84 is able to access data quickly by performing a partial data access at the same time as the tag comparison, instead of waiting for the tag comparison to finish first. After the tag comparison is done, one sense amplifier fires after detecting a hit signal and data is read down global bitline 102. Because associative cache 84 has four ways, the savings in power consumption and money (from resources to build lines for each way) becomes even more substantial.

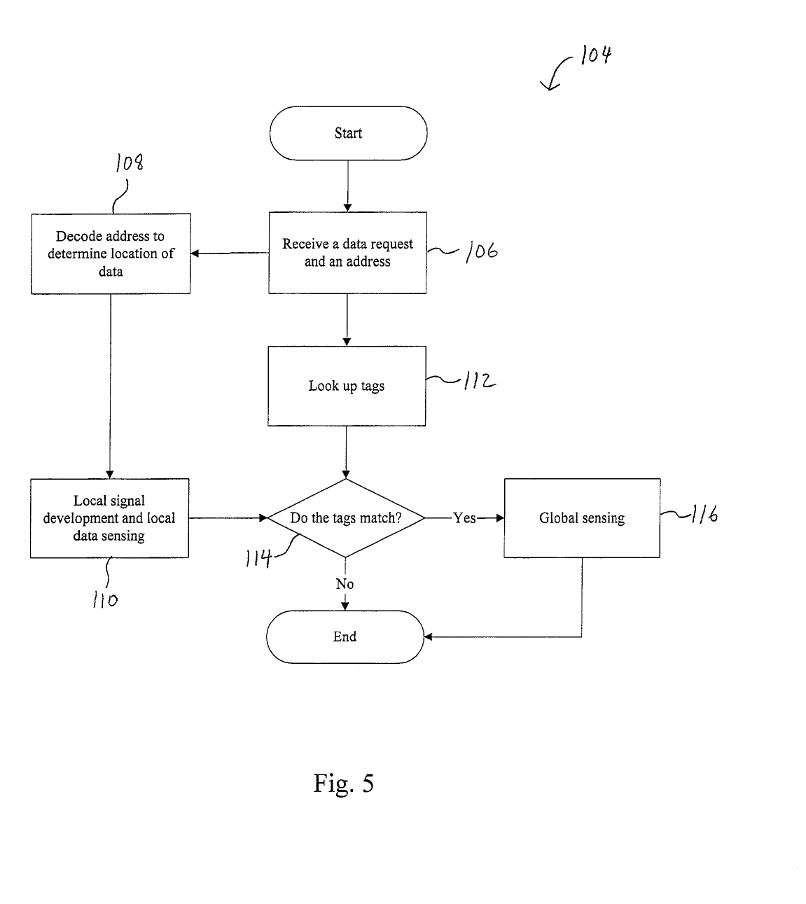

FIG. 5 is a flow chart of a method 104 for way select. Method 104 begins at a block 106 where a data request and an address are received. In a block 108, the address is decoded to determine a location of the data requested. After the location of the data is determined, a local signal is developed and local data is sensed to prepare for the possibility of global sensing in a block 110. While the address is being decoded, a tag look-up of a particular way is performed in a block 112. Then the tag is compared with the address to determine whether there is a hit or a miss in a block 114. If the tags match, then there is a hit and data is read from the location in a block 116 and then method 104 ends. If the tags do not match, then there is a miss, and method 104 ends.

Other embodiments of the invention will be apparent to those skilled in the art from consideration of the specification and practice of the invention. Furthermore, certain terminology has been used for the purposes of descriptive clarity, and not to limit the present invention. The embodiments and preferred features described above should be considered exemplary, with the invention being defined by the appended claims.

What is claimed is:

1. A cache access system, comprising:
a plurality of ways;
decoders coupled to each of said ways, wherein each decoder is to find a data location in one said plurality of ways based on an address;
a tag unit to compare said address with a tag array and to generate a hit/miss signal; and
sense amplifiers coupled to each of said ways, wherein one of said sense amplifiers is to read data from said data location if it receives said hit/miss signal as a hit.

2. A cache data access system as recited in claim 1, further comprising a plurality of control units coupled between the tag unit and the sense amplifiers, wherein said control unit receives a hit/miss signal and controls the sense amplifiers.

3. A cache data access system as recited in claim 2, wherein said address is generated by a CPU.

4. A cache data access system as recited in claim 3, wherein said address includes an index, a tag, and an offset.

5. A cache data access system as recited in claim 4, wherein said data read by the one of the sense amplifiers is transmitted on a global bitline.

6. A cache data access system as recited in claim 5, wherein the sense amplifiers are coupled to each of said ways through a local bitline.

7. A method for accessing a cache, comprising:
receiving a data request having an address;
decoding said address to determine locations of said data request in a plurality of ways in said cache;
providing data from said locations in said plurality of ways to a plurality of sense amplifiers; and
generating a hit signal for one of said sense amplifiers based on a comparison of said address with a tag array.

8. A method for accessing a cache as recited in claim 7, further comprising outputting the data from the one of the sense amplifiers.

9. A method for accessing a cache as recited in claim 8, wherein the providing data from the locations in the plurality of ways includes developing a local signal.

10. A method for accessing a cache as recited in claim 9, wherein the providing data from the locations in the plurality of ways includes sensing local data.

11. A method for accessing a cache as recited in claim 10, wherein the providing data from the locations in the plurality of ways includes developing a local signal.

12. A method for accessing a cache as recited in claim 11, wherein the providing data from the locations in the plurality of ways and the generating a hit signal occur at the same time.

13. A set of instructions residing in a storage medium, said set of instructions capable of being executed by a processor for searching data stored in a mass storage device comprising:
receiving a data request having an address;
decoding said address to determine locations of said data request in a plurality of ways in said cache;
providing data from said locations in said plurality of ways to a plurality of sense amplifiers; and
generating a hit signal for one of said sense amplifiers based on a comparison of said address with a tag array.

14. A method for accessing a cache as recited in claim 13, further comprising outputting the data from the one of the sense amplifiers.

15. A method for accessing a cache as recited in claim 14, wherein the providing data from the locations in the plurality of ways includes developing a local signal.

16. A method for accessing a cache as recited in claim 15, wherein the providing data from the locations in the plurality of ways includes sensing local data.

17. A method for accessing a cache as recited in claim 16, wherein the providing data from the locations in the plurality of ways includes developing a local signal.

18. A method for accessing a cache as recited in claim 17, wherein the providing data from the locations in the plurality of ways and the generating a hit signal occur at the same time.
